(19) United States
(12) Patent Application Publication
(10) Pub. No.: US 2008/0012692 A1
(43) Pub. Date: Jan. 17, 2008

(54) SYSTEMS AND METHODS FOR PROVIDING SPECTRAL FEEDBACK TO VISUALLY CONVEY A QUANTITATIVE VALUE

(76) Inventor: Michael Pyle, Draper, UT (US)

Correspondence Address: BAKER & ASSOCIATES PLLC, 470 EAST NINTH AVENUE, SALT LAKE CITY, UT, 84103, US

(21) Appl. No.: 11/770,057

(22) Filed: Jun. 28, 2007

Related U.S. Application Data
(60) Provisional application No. 60/806,247, filed on Jun. 29, 2006.

(51) Int. Cl. G08B 5/00; H05B 39/00; H05B 41/00

(52) U.S. Cl. 340/332

(57) ABSTRACT

One embodiment relates to a complex quantitative media performance metric spectral display system. The system displays a spectral color that accurately represents a complex quantitative value of a media performance metric. The system includes an integrated electrical component system, a parameter input module, a control module, and a spectral output module. The integrated electrical component system relates to audio and/or video media functionalities. The parameter input module is configured to receive a parameter that corresponds to a media performance metric of the integrated electrical component system such as internal temperature, proximate electromagnetic radiation, video brightness, or audio volume. The control module includes a correlation algorithm configured to correlate the parameter with a color. The control module also includes a spectral component algorithm configured to correlate the color with a set of red, green, and blue intensity components. The spectral output module includes a plurality of electrical components independently configured to display a single visual wavelength.

### RELATED APPLICATIONS

This application claims priority to U.S. provisional application Ser. No. 60/806,247 filed Jun. 29, 2006, the contents of which are incorporated by reference.

### FIELD OF THE INVENTION

The invention generally relates to systems and methods for providing spectral feedback to visually convey a quantitative value. In particular, the invention relates to systems and methods for conveying complex media performance related information utilizing a color display.

### BACKGROUND OF THE INVENTION

Audio and video components are designed to convert electrical signals into either audio or video outputs for conveying information to a user for purposes of entertainment or communication. For example, a television converts an electrical input signal into a visual image and a corresponding audible output. Improvements in technology have increased the performance of these devices so as to produce higher quality outputs. The quality of an audio or video output may be defined by the clarity or amount of undesirable signal present in the output. For example, a high quality audio output will include a minimal amount of audible noise such as static, crosstalk, etc. Likewise, a high quality video image will include a minimal amount of visual noise such as stray images, color patterns, distortion, etc.

Home entertainment has evolved from separate audio and video components to integrated multi-component systems that are used to maximize performance. For example, audio systems are designed to produce a relatively high level of audio output for purposes of listening to music or other types of audio information. Whereas, video components typically include the ability to produce both audio and video outputs. However, the audio systems included with most video components generally produce a lower quality output than a corresponding dedicated audio component. Therefore, components have been developed to couple with one another so as to increase performance or provide additional functionality. Various components are commonly electrically coupled together, including video output devices, audio output devices, video input devices, audio input devices, networking devices, etc.

Modern presentations utilize audio and visual information to communicate concepts in an effective and efficient manner. For example, presenters often utilize Powerpoint™ presentations to visually communicate concepts during a presentation. Presentations may also include media clips or audio recordings. As with home entertainment, higher quality audio and video is preferable to effectively convey concepts or entertain an audience during presentations.

The performance, reliability, and/or quality level of audio and video components is affected by a multitude of variables and characteristics. Advances in electrical technology alone do not necessarily solve certain performance problems with respect to audio and video components. For example, the quality of video produced by a video output component will be significantly affected by a power supply that includes an abundance of electrical abnormalities regardless of the video technology included in the particular video output device. It is also necessary for components to operate and intercouple with one another in a simplified, seamless and reliable manner so as to be utilized to the full potential. Therefore, there is a need in the industry for systems and methods of increasing audio and video performance by incorporating technologies that maximize performance characteristics. In addition, there is a need in the industry for systems and methods that allow users to more effectively utilize audio and video components, including integration, interfaces, and operational systems.

### SUMMARY OF THE INVENTION

Embodiments of the present invention relate to systems and methods for conveying complex media performance related information utilizing a color display. One embodiment relates to a complex quantitative media performance metric spectral display system. The system displays a spectral color that accurately represents a complex quantitative value of a media performance metric. The system includes an integrated electrical component system, a parameter input module, a control module, and a spectral output module. The integrated electrical component system relates to audio and/or video media functionalities. The parameter input module is configured to receive a parameter that corresponds to a media performance metric of the integrated electrical component system such as internal temperature, proximate electromagnetic radiation, video brightness, or audio volume. The control module includes a correlation algorithm configured to correlate the parameter with a color. The control module also includes a spectral component algorithm configured to correlate the color with a set of red, green, and blue intensity components. The spectral output module includes a plurality of electrical components independently configured to display a single visual wavelength. A second embodiment relates to a method for displaying a complex quantitative media performance metric on an integrated electrical component system.

Conventional electrical devices display complex quantitative information numerically or graphically so as to represent minor variations in the complex value. Conventional graphical displays of complex numerical information often utilize bars or circles of light that fill proportionately to the complex numerical value they represent. These conventional graphical displays generally require a large amount of space to convey the respective values. Unfortunately, there is little space available on modern electrical devices. Numerical displays do not provide users with intuitive information and often must be decoded to be understood. For example, a numerical value od 12 for an audio volume has no meaning until it is associated with a current decibel level or past experience. Embodiments of the present invention overcome these limitations of the prior art.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular—rather than complete—portions of the systems and methods of making and using the system according to the invention. In the Figures, the physical dimensions may be exaggerated for clarity. The figure numbers correspond to the respective page number.

FIG. 1 illustrates an exploded perspective view of an integrated electrical component system, which may represent a suitable operating environment for embodiments of the present invention;

FIG. 2 illustrates a block diagram of a complex quantitative media performance metric spectral display system in accordance with one embodiment of the present invention;

FIG. 3 illustrates a flow chart of a method for displaying a complex quantitative media performance metric of an integrated electrical component system in accordance with a second embodiment of the present invention; and

FIG. 4 illustrates a mathematical relationship diagram of the spectral correlation algorithm in accordance with embodiments of the present invention.

### DETAILED DESCRIPTION OF THE INVENTION

Embodiments of the present invention relate to systems and methods for conveying complex media performance related information utilizing a color display. One embodiment relates to a complex quantitative media performance metric spectral display system. The system displays a spectral color that accurately represents a complex quantitative value of a media performance metric. The system includes an integrated electrical component system, a parameter input module, a control module, and a spectral output module. The integrated electrical component system relates to audio and/or video media functionalities. The parameter input module is configured to receive a parameter that corresponds to a media performance metric of the integrated electrical component system such as internal temperature, proximate electromagnetic radiation, video brightness, or audio volume. The control module includes a correlation algorithm configured to correlate the parameter with a color. The control module also includes a spectral component algorithm configured to correlate the color with a set of red, green, and blue intensity components. The spectral output module includes a plurality of electrical components independently configured to display a single visual wavelength. A second embodiment relates to a method for displaying a complex quantitative media performance metric on an integrated electrical component system. Also, while embodiments of the present invention are described in the context of spectral indicators on remote electrical control devices, it is appreciated that the teachings of the present invention are applicable to other areas.

The following terms are defined for purposes of utilization throughout this application:

Complex value—A non-boolean value that includes at least three states. For example, an audio volume indication may include at least 25 independent states related to particular decibel output levels.

Media performance metric—A parameter relating to the performance of an electrical component system for performing audio/video functionalities, including input and output.

Quantitative value—A numerical value of a particular parameter.

Mathmatical position—A relative positioning of a value between a low end and high end of a range of numbers.

Visual sum—A resulting visual appearance that includes a plurality of independent components. For example, when red and blue colors are displayed in a particular proximity to one another, the visual sum may appear entirely green. A visual sum may also be affected by partially obstructing a portion of each of the components. For example, a single recess or transparent view screen may provide a partially obstructed but equidistantly spaced view of a red, green, and blue LED.

Visual spectrum—The range of wavelengths visible to the human eye.

Electrical component board—A board configured to house a plurality of electrical components, wherein the electrical components are mechanically coupled to the board and electrically coupled to one another. In addition, electrical component boards may mechanically and electrically couple with a bus or receiver unit to facilitate support. An electrical component board may include a mounting structure for normalizing the size of multiple standard printed circuit boards (PCB).

Vertical alignment—A device that is vertically aligned or positioned such that its longest dimension is oriented in a substantially vertical plane or normal to a supporting surface. For example, a telephone pole is aligned vertically.

Plenum—A module for redirecting air flow. In the illustrated embodiments, the plenum is disposed below the electrical component boards.

Audio input device—An electrical device configured to produce audio signals including but not limited to a receiver, tuner, digital media player (CD, DVD, etc.), television, computer, gaming console, portable media player, etc.

Audio output device—An electrical device configured to receive and broadcast audio signals in an audible format, including but not limited to speakers, subwoofers, tweeters, headphones, etc.

Video input device—An electrical device configured to produce video signals including but not limited to a cable receiver, tuner, television, computer, gaming console, etc.

Video output device—An electrical device configured to receive and broadcast video signals in a visual format, including but not limited to a monitor, television, cell phone, portable media player, etc.

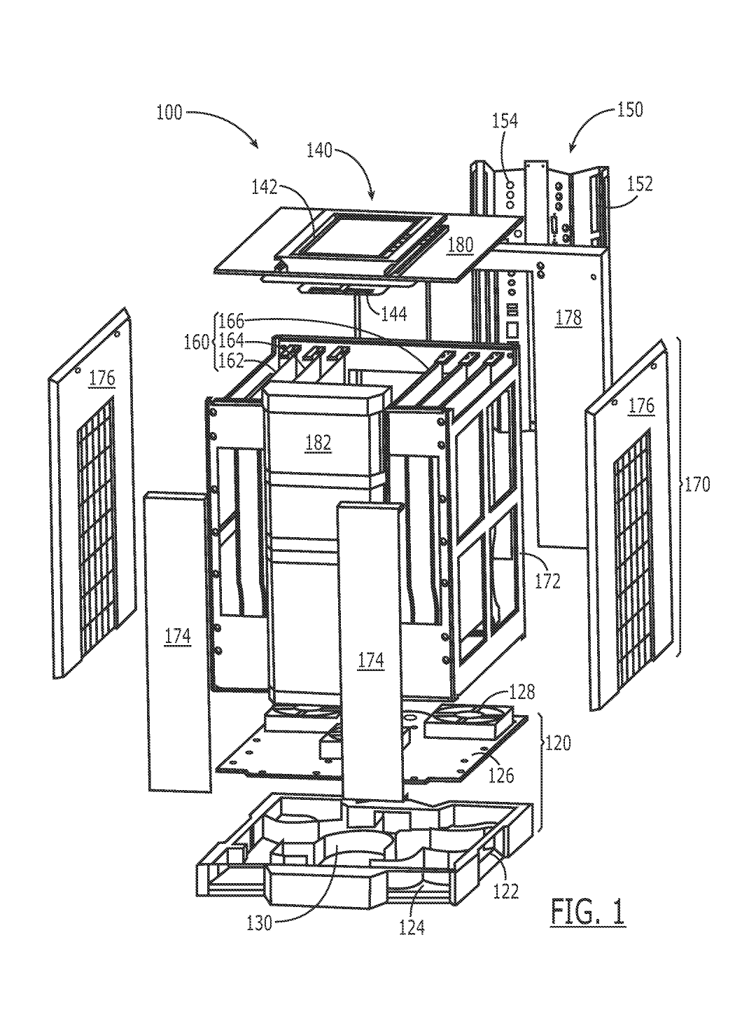

Reference is initially made to FIG. 1, which illustrates an exploded perspective view of an integrated electrical component system which may represent a suitable operating environment for embodiments of the present invention, designated generally at 100. The illustrated system also contains a particular cooling system, which will be described briefly below for reference purposes. The vertical nature of the illustrated system 100 affects the orientation of the associated interconnection panel 150. The system 100 includes a set of electrical component boards 160, a plenum 120, an outlet 140, and a housing 170. The illustrated electrical component boards 160 include six boards, three of which are designated respectively as a first, second, and fourth board 162, 164, 166. Various systems may hold as few as two electrical component boards and still incorporate the teachings of the present invention. The illustrated electrical component boards 160 include individual electrical components electrically intercoupled as a conventional printed circuit board to provide audio and/or video functionalities. Each of the electrical component boards 160 may be a conventional audio or video component without its housing, such as a DVD player, game console, DVR, etc. The electrical component boards 160 are also electrically intercoupled with one another to further provide audio and/or video functionalities. The electrical intercoupling of the individual electrical component boards 160 is configured to integrate their functionalities and includes both software and hardware integration. To facilitate the proper air flow, the electrical component boards 160 are oriented vertically with the longest axis oriented perpendicular to the supporting surface. The orientation of the boards 160 is mechanically supported by the housing 170 and more particularly by an internal chassis or racking system 172. The electrical component boards 160 may further include mounting structures so as to ensure consistent shaping among the individual boards. The internal chassis or racking system creates a particular spacing between the boards as illustrated.

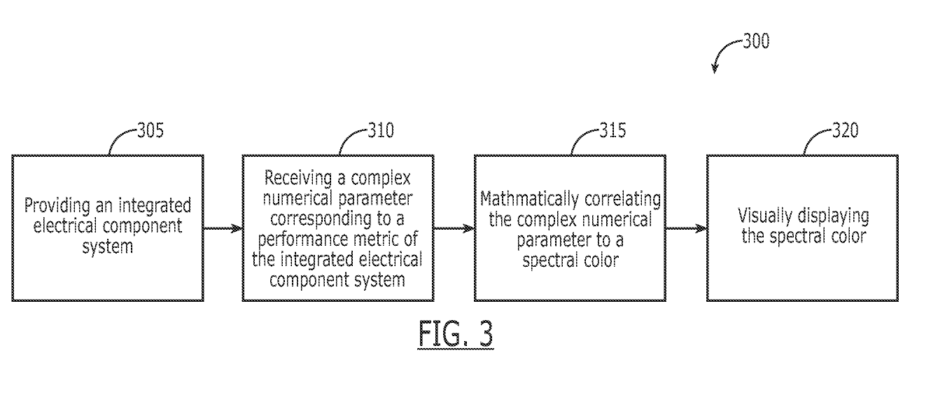

The plenum 120 is disposed below the housing 170 and the electrical component boards 160. The plenum 120 facilitates the intake and direction of ambient air for the cooling system 100. The plenum 120 includes a front inlet 124, a lateral inlet 122, a set of air guides 130, a cover 126, and a set of fans 128. The inlets 122, 124 receive ambient air from the surrounding environment and allow it to enter the system at a location vertically below the electrical component boards 160. This location of air intake is critical for the overall system's ability to utilize the natural process of convection for heat transfer. The set of air guides 130 and cover 126 create independent air flow channels that horizontally direct air flow to regions that are vertically aligned between the individual electrical component boards 160. In the illustrated embodiment, these vertically aligned locations correspond to the positioning of the fans 128. It should be noted that the fans 128 enhance the natural convectional air flow and are optional components. Therefore, even if the fans 128 are removed or begin to malfunction, the system 100 will circulate ambient air through convection alone. In the illustrated embodiment, the fans 128 enhance the air flow by further directing the air vertically from the plenum 120 between the electrical component boards 160. Additional details and description of the plenum 120 and its associated-system wide functionality and internal technology will be discussed in reference to FIGS. 3A-3B.

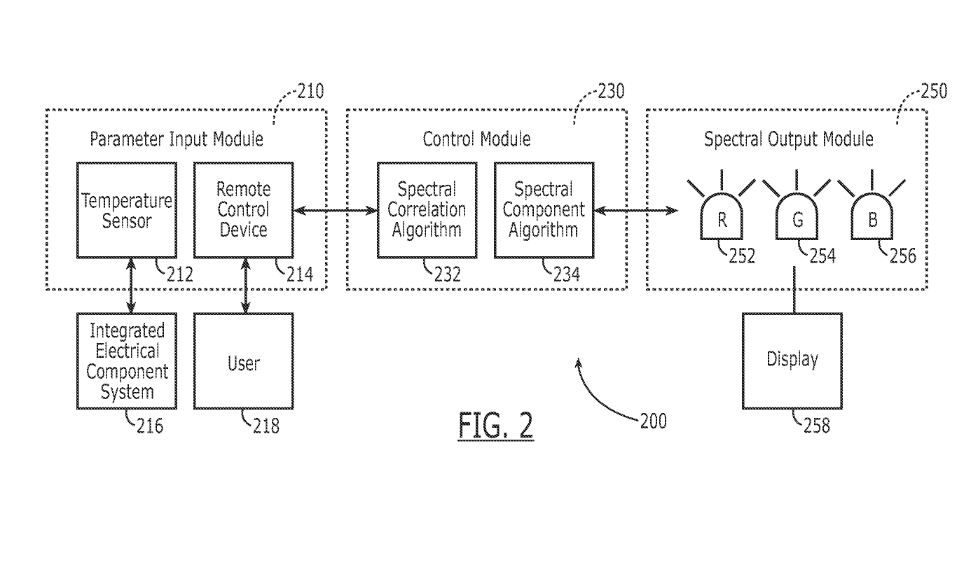

The housing 170 substantially encases and supports the electrical component boards 160 in the vertically oriented configuration illustrated and described above. The region within the housing 170 receives air flow vertically from the plenum 120, allowing it to flow vertically around and between the electrical component boards 160 and then exhaust toward the outlet 140. The air flow adjacent to the electrical component boards is naturally heat affected because of the difference in heat between the ambient air received from the plenum 120 and the heat generated by the operation of the electrical component boards 160. To normalize the heat between the two, the heat from the electrical component boards 160 is released, thereby heat affecting the air. This heat exchange process causes the air to rise in both temperature and position, thereby naturally causing the vertical air flow cycle of the system 100 through convection. The air flow cycle will be illustrated and described in more detail with reference to FIGS. 2A-2C.

The housing 170 includes a plurality of panels, a set of front panels 174, a set of side panels 176, a rear panel 178, and a top panel 180. The housing 170 further includes an internal chassis 172, a front console 182, and a rear connection panel 150. The panels 174, 176, 178, 180 mechanically couple to one another and the internal chassis 172 to define an internal region in which the electrical component boards 160 are housed. The encasement of electrical components is well used in the electronics industry for purposes such as dust protection, electrical isolation, and noise dampening. The front console 182 includes various electrical interconnections, human interface modules, and remote control transceiver locations. The interconnection panel 150 provides a plurality of electrical connections for input and output to the electrical component boards 160. The interconnection panel includes a retaining member 152 and a set of electrical couplers 154.

The outlet 140 is disposed on the top cover 180 of the housing 170 to facilitate the exhaust of the temperature affected air through convectional heat transfer principles. The outlet 140 is disposed above the electrical component boards 160 and at the apex of the system 100 to enable heated air to naturally rise away from the electrical component boards 160 and exhaust out of the system 100. The outlet 140 includes an internal baffle 144 and an external port 142. The temperature affected air from within the housing will flow both horizontally and vertically around the baffle 144 and out through the external port 144 so as to be recombined with the ambient air, thereby creating an air flow cycle.

Reference is next made to FIG. 2, which illustrates a block diagram of a complex quantitative media performance metric spectral display system, designated generally at 200. The system 200 displays a spectral output color accurately representing a complex media performance metric of an integrated electrical component system 216. For example, in conjunction with the media system 100 illustrated in FIG. 1, the system 200 may display a particular color between blue and red that accurately corresponds to the internal temperature within the housing 170 of the integrated electrical component system. Alternatively, the system 200 may display a color that accurately corresponds to the audible volume output signal produced by the system 100. By displaying these complex values as a color, a user is able to intuitively respond in a manner that optimizes media performance of a particular system. In addition, the display characteristics of a color are significantly smaller than that of a corresponding bar graph, pie chart, etc.

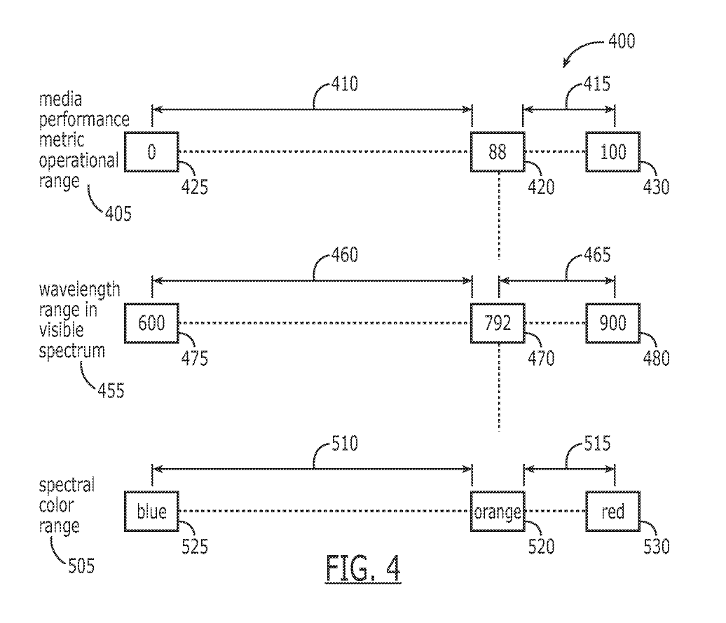

The system 200 includes a parameter input module 210, a control module 230, and a spectral output module 250. The parameter input module 210 includes a complex numerical parameter corresponding to a media performance metric of the integrated electrical component system 216. The complex numerical parameter is a complex value in that it includes at least three states (as opposed to a Boolean parameter which has only 2 states). The media performance metric is any parameter that affects the media performance of the integrated electrical component system 216. Media performance includes the ability to perform audio and video functionalities including but not limited to input, output, display, interface, etc. Each media performance metric has a particular range of operational values. For example, temperature may include values between 0 and 100 corresponding to a Celsius measurement. Therefore, a complex numerical parameter corresponding to temperature may have the quantitative value of 88, indicating a measurement within the range of 0 and 100. The quantitative value of 88 will also be numerically spaced between each end of the range by a particular amount. For example, 88 is 88 integer positions above 0 and 22 integer positions below 100; the relative mathmatical positioning between the two ends of the operational range define a mathematical position. This relationship will also be further described and visually represented with reference to FIG. 4. The parameter input module 210 includes a temperature sensor 212 and a remote control device 214. The temperature sensor 212 may be positioned and configured to measure the internal temperature of an enclosed region such as the housing 170 in the operating embodiment illustrated in FIG. 1. Various temperature sensors or thermistor components may be utilized in accordance with well known electrical configurations. Therefore, the temperature sensor 212 may generate a complex numerical parameter corresponding to the temperature performance metric. Likewise, the remote control device 214 may be a wireless user input device commonly associated with audio and/or video components. The remote control device 214 may enable a user to increase/decrease the audio volume level of the integrated electrical component system 216. Various wireless technologies, PCB boards, and configurations may be utilized in the remote control device 216. Therefore, the remote control device 214 may generate a complex numerical parameter corresponding to the audio volume performance metric.

The control module 230 includes a spectral correlation algorithm 232 and a spectral component algorithm 234. The control module 230 may operationally include a microprocessor (not illustrated) that incorporates the functionality of the spectral correlation algorithm 232 and/or the spectral component algorithm 234. The spectral correlation algorithm 232 correlates the complex numerical parameter to a spectral color. The spectral color corresponds to a numerical wavelength value that is mathematically positioned within a range of wavelengths at the same mathematical position as the complex numerical parameter. Therefore, the numerical wavelength is spaced from each of the ends of the range of wavelengths by a proportionately equal amount to that which the complex numerical value within the operational range. The spectral correlation algorithm 232 is described and illustrated in more detail with reference to FIG. 4. The spectral component algorithm determines the spectral components intensities and/or wavelengths of the spectral color. In the illustrated system 200, this corresponds to determination of the necessary relative intensities of a red LED 252, green LED 254, and blue LED 256 to produce a visual sum of the spectral color. Various mathematical relationships may be utilized for this correspondence depending on the display 258 and relative positioning of the LEDs 252, 254, 256. Alternatively, the spectral component algorithm 234 could generate spectral components including both wavelengths and intensities, which may be associated with other non-LED illumination type components.

The spectral output module 250 includes a plurality of electrical components, each of which configured to display a single wavelength within the visible spectrum. In the illustrated system, the electrical components include a red LED 252, a green LED 254, and a blue LED 256. The LEDs 252, 254, 256 are positioned on the integrated electrical component system 216 at a location including but not limited to an exterior housing or a remote control. The LEDs are electrically activated in a manner to produce a display 258 of the visual sum of their respective illumination outputs. Therefore, a display 258 corresponding to the color purple is achieved by electrically activating the red and blue LEDs 252, 256. The display 258 may be any type of transparent window, recess, or opening which permits a visual sum of the respective LEDs 252, 254, 256 when viewed externally by a user. For example, the LEDs 252, 254, 256 could be positioned on a printed circuit board of a remote control device 214, and the housing may be configured so as to include a recess displaying a visual sum of the LEDs 252, 254, 256 on an exterior surface of the remote control device 214. Various other display configurations and visual sum technologies may be utilized in conjunction with the present invention. Likewise, various other spectral component electrical devices may be utilized.

Reference is next made to FIG. 3, which illustrates a flow chart of a method for displaying a complex quantitative media performance metric of an integrated electrical component system, designated generally at 300. The method includes providing an integrated electrical component system, act 305. One example of an integrated electrical component system is described and illustrated with reference to FIG. 1. A complex numerical parameter is received that corresponds to a performance metric of the integrated electrical component system, act 310. The complex numerical parameter may be measured by a measurement device such as a temperature sensor or an electromagnetic sensor. The complex numerical sensor may also be measured as a function of a received user input, as in the case of user-adjustable audible volume measurement. A spectral color is correlated with the complex numerical parameter, act 315. The correlation of the spectral color with the complex numerical value may also include analyzing the proportional relationship between the quantitative value of the complex numerical parameter in relation to the range of values for the media performance metric and determining a wavelength with the same proportional relationship within the corresponding wavelength range. The spectral color is visually displayed as a visual sum of a plurality of spectral components, act 320. The method may also include the correlation of the spectral color wavelength to a plurality of component color wavelengths and relative intensities. The plurality of component color wavelengths and relative intensities visually sum to the spectral color. The plurality of component color wavelengths may correspond with standard red, green, and blue wavelengths.

Reference is next made to FIG. 4, which illustrates a mathematical relationship diagram of the spectral correlation algorithm, designated generally at 400. The top chart illustrates a media performance metric range 405 between a low end 425 value of 0 and a high end 430 value of 100. The quantitative value of the complex numerical parameter 420 is 88. The low end mathematical distance 410 of the complex numerical parameter 420 from the low end 425 has value of 88. The high end mathematical distance 415 has value of 22. Therefore, the mathematical distance of the complex numerical parameter 420 is four times further from the low end 425 than the high end 430. These relative distances translate into a particular mathematical position. The wavelength value 792 is correspondingly positioned within the wavelength range in the visible spectrum 455 to the particular mathematical position. Therefore, the selected wavelength 470 having a value of 792 is positioned a particular low end mathematical distance 460 from the low end 475, which is four times greater than the high end mathmatical distance 465 from the high end 480. The spectral color range 505 corresponds to the visual appearance of the wavelengths in the wavelength range 455. The selected color or spectral color 520, which has an appearance of orange, is visually positioned a low end spectral distance 510 from the low end 525 which is four times greater than the high end spectral distance 515 from the high end 530.

In one particular PCB board implementation (not illustrated), a microcontroller is electrically coupled to a red, green, and blue LED. A pulse width modulated (PWM) signal is transmitted to each of the LEDs, in which the duty cycle of the PWM signal enables the individual manipulation of the individual current applied to each LED. The current across each LED corresponds to a desired intensity for the particular LED. Therefore, to generate a combined visual sum of a particular color, the current across each of the respective LEDs is adjusted accordingly. The PCB board is positioned within a housing such that a single visual display is visible that produces a visual sum of the illumination produced by all three LEDs. Therefore, any output display color can be generated by selectively applying current to one or more of the LEDs individually or in combination. For example, a purple output display could be generated by applying current to the red and blue LEDs but not the green LEDs. The described PCB board may be incorporated into larger PCB display boards, remote control devices, etc.

Various other embodiments have been contemplated, including combinations in whole or in part of the embodiments described above.

What is claimed is:

1. A complex quantitative media performance metric spectral display system comprising:
an integrated electrical component system;
a parameter input module including a complex numerical parameter corresponding to a media performance metric of the integrated electrical component system, wherein the quantitative value of the complex numerical parameter is disposed at a particular mathematical position within a range of operational values for the media performance metric;
a control module data coupled to the parameter input module, wherein the control module includes a spectral correlation algorithm configured to mathematically correlate the complex numerical parameter to a spectral color, wherein the spectral color corresponds to a wavelength that is mathematically disposed within a range of wavelengths at the particular mathematical position, wherein the range of wavelengths are within the visible spectrum; and
a spectral output module including a plurality of electrical components positioned and activated on the integrated electrical component system to produce a display of the visual sum of the electrical components.

2. The system of claim 1, wherein the control module includes a spectral component algorithm configured to mathematically correlate the spectral color to a plurality of spectral component colors.

3. The system of claim 2, wherein the plurality of spectral component colors include red, green, and blue, and wherein the plurality of electrical components includes a red LED, green LED, and blue LED.

4. The system of claim 1, wherein the media performance metric is an internal temperature measurement of the integrated electrical component system, and wherein the parameter input module includes a temperature sensor.

5. The system of claim 1, wherein the media performance metric is a user selectable media performance metric, and wherein the parameter input module includes a user input remote control device.

6. The system of claim 5, wherein the user selectable media performance metric is the audible volume of an audio output signal of the integrated electrical component system.

7. The system of claim 1, wherein the range of wavelengths corresponds to the range of wavelengths between the wavelengths corresponding to blue and red.

8. The system of claim 1, wherein the integrated electrical component system includes at least one of an audio input, video input, audio output, and video output type functionality.

9. The system of claim 1, wherein the integrated electrical component system includes:
at least one electrical component board including a plurality of electrically interconnected components; and
a housing configured to mechanically support the at least one electrical component board, wherein the housing includes an internal region in which the at least one electrical component board is disposed.

10. A method for displaying a complex quantitative media performance metric of an integrated electrical component system comprising the acts of:
providing an integrated electrical component system;
receiving a complex numerical parameter corresponding to a media performance metric of the integrated electrical component system, wherein the quantitative value of the complex numerical parameter is disposed at a particular mathematical position within a range of operational values for the media performance metric;
mathematically correlating the complex numerical parameter to a spectral color, wherein the spectral color corresponds to a wavelength that is mathematically disposed within a range of wavelengths at the particular mathematical position, wherein the range of wavelengths are within the visible spectrum; and
visually displaying the spectral color as a visual sum of a plurality of spectral components.

11. The method of claim 10, further including the acts of:
mathematically correlating the spectral color wavelength to a plurality of spectral component color wavelengths and relative intensities, wherein the spectral component color wavelengths and relative intensities correspond to spectral component colors that visually sum the spectral color; and
electrically inducing a plurality of individual electrical components corresponding to the spectral component color wavelengths and relative intensities.

12. The method of claim 11, wherein the act of mathematically correlating the spectral color wavelength to a plurality of spectral component color wavelengths and relative intensities includes correlating the spectral color wavelength to red, green, and blue spectral color components.

13. The method of claim 11, wherein the act of mathematically correlating the spectral color wavelength to a plurality of spectral component color wavelengths and relative intensities includes transmitting a pulse width modulated electrical signal to each of the individual electrical components causing a particular current to be applied to each of the individual electrical components.

14. The method of claim 11, wherein the act of visually displaying the spectral color includes the act of positioning the individual electrical components within a housing, wherein the housing includes a transparent region that is equidistantly spaced between the individual electrical components.

15. The method of claim 10, wherein the act of receiving a complex numerical value corresponding to a media performance metric of the integrated electrical component system includes measuring an internal temperature of the integrated electrical component system.

16. The method of claim 10, wherein the act of receiving a complex numerical value corresponding to a media performance metric of the integrated electrical component system includes receiving a user selectable media performance metric.

17. The method of claim 10, wherein the act of mathematically correlating the complex numerical parameter to a spectral color includes applying a correlation algorithm that includes the act of:
analyzing the proportional relationship of the quantitative value of the complex numerical parameter in relation to the range of values for the media performance metric; and
determining a wavelength with the same proportional relationship within the range of wavelengths.

18. The method of claim 10, wherein the act of visually displaying the spectral color includes electrically activating a plurality of LEDs that visually sum to the spectral color.

19. The method of claim 10, wherein act of providing an integrated electrical component system includes providing at least one electrical component board including a plurality of electrically interconnected components and a housing configured to mechanically support the at least one electrical component board, wherein the housing includes an internal region in which the at least one electrical component board is disposed.

20. A method for displaying a complex quantitative media performance metric of an integrated electrical component system comprising the acts of:
providing a integrated electrical component system;
receiving a complex numerical parameter corresponding to a media performance metric of the integrated electrical component system, wherein the quantitative value of the complex numerical parameter is disposed at a particular mathematical position within a range of operational values for the media performance metric;
mathematically correlating the complex numerical parameter to a spectral color, wherein the spectral color corresponds to a wavelength that is mathematically disposed within a range of wavelengths at the particular mathematical position, wherein the range of wavelengths are within the visible spectrum;
mathematically correlating the spectral color wavelength to red, green, and blue spectral color intensity components, wherein the intensity of the red, green, and blue spectral color intensity components visually sum the spectral color;
electrically inducing a red, green, and blue LED according to the corresponding red, green, and blue spectral color intensity components; and
visually displaying the spectral color as a visual sum of a plurality of spectral components.
